(19) United States
(12) Patent Application Publication
(10) Pub. No.: US 2007/0040078 A1
(43) Pub. Date: Feb. 22, 2007

(54) Power driven tilting inversion exerciser

(76) Inventor: Lo Pin Wang, Taichung (TW)

Correspondence Address: CHARLES E. BAXLEY, ESQ., 90 JOHN STREET, THIRD FLOOR, NEW YORK, NY, 10038, US

(21) Appl. No.: 11/204,525

(22) Filed: Aug. 16, 2005

(51) Int. Cl. A47J 47/16

(52) U.S. Cl. 248/144; 248/145

(57) ABSTRACT

A tilting inversion exerciser includes a table rotatably supported on a supporting stand for supporting a user, one or more levers having a middle portion rotatably attached to the supporting stand and having one end pivotally coupled to the table, and a rotating device for rotating the lever relative to the supporting stand, to rotate the table relative to the supporting stand, and to allow the table to be rotated relative to the supporting stand to a vertical dependent position. For example, a motor-driven threading device or an actuator may be coupled to the other end of the lever, for rotating the lever and thus the table relative to the supporting stand to the vertical position relative to the supporting stand.

### BACKGROUND OF THE INVENTION

1. Field of the Invention

The present invention relates to a tilting inversion exerciser, and more particularly to a tilting inversion exerciser having a power rotating device for rotating the tilting inversion exerciser relative to the supporting stand.

2. Description of the Prior Art

Typical tilting inversion exercisers comprise a base or table pivotally or rotatably supported on a lower support stand, for supporting a user thereon, and for allowing the user to tilt or to incline the table relative to the lower support, in order to conduct the typical tilting inversion exercises.

For example, U.S. Pat. No. 4,915,101 to Cuccia discloses one of the typical rotatable treatment tables comprising adjustable support assemblies, and also comprising a base or table pivotally or rotatably supported on a lower support, an extendible and elongate elevation device coupled to the table, for rotating the table relative to the lower support.

However, the extendible and elongate elevation device is directly coupled to the table, and may only be used to tilt the table relative to the lower support, but may not be used to rotate the table relative to the lower support to a vertical position relative to the lower support and the ground, such that the user may not conduct the inversion exercises.

U.S. Pat. No. 5,840,001 to Schedel discloses another typical therapy exercise table also comprising a platform pivotally or rotatably attached to and supported on a lower support, a platform actuator coupled to the platform, for rotating the platform relative to the lower support.

However, similarly, the platform actuator is also directly coupled to the platform, and may only be used to slightly tilt or incline the platform relative to the lower support only, but may not be used to rotate the platform relative to the lower support to a vertical position relative to the lower support and the ground, such that the user may not conduct the inversion exercises.

The present invention has arisen to mitigate and/or obviate the afore-described disadvantages of the conventional tilting inversion exercisers.

### SUMMARY OF THE INVENTION

The primary objective of the present invention is to provide a tilting inversion exerciser including a power rotating or driving device for rotating the tilting inversion exerciser relative to the supporting stand and for allowing the table to be rotated relative to the lower support to a vertical position relative to the lower support and the ground, and for allowing the user to conduct the inversion exercises.

In accordance with one aspect of the invention, there is provided a tilting inversion exerciser comprising a supporting stand, a table rotatably supported on the supporting stand for supporting a user thereon, at least one lever including a middle portion rotatably attached to the supporting stand with a pivot shaft, and includes a first end pivotally coupled to the table, and a rotating device for rotating the lever relative to the supporting stand, to rotate the table relative to the supporting stand, and for allowing the table to be rotated relative to the lower support to a vertical position relative to the lower support and the ground, and for allowing the user to conduct the inversion exercises.

The table includes an upper portion coupled to the first end of the lever with such as a link, and may further include an ankle holder attached thereto, for detachably securing ankle portions of the user to the table.

The lever includes a second end portion, and the rotating device includes a motor-driven threaded member coupled to the second end of the lever, for rotating the lever relative to the supporting stand.

The rotating device includes a tube coupled to the second end of the lever and threaded with the threaded member, for allowing the tube to be moved toward or away from the threaded member. The rotating device further includes a frame having a first end pivotally coupled to the second end of the lever and having the tube extended therefrom.

The rotating device includes a motor pivotally attached to the supporting stand, and the threaded member is coupled to and rotated and driven by the motor. The motor includes a sleeve extended therefrom and engaged onto the threaded member, for shielding and protecting the threaded member, and for preventing people from being hurt by the relative movement between the tube and the threaded member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a tilting inversion exerciser in accordance with the present invention;

FIG. 2 is a perspective view of the tilting inversion exerciser, similar to FIG. 1, in which a portion of the tilting inversion exerciser has been shown in dotted lines, for allowing the linking or coupling portion of the tilting inversion exerciser to be clearly shown and seen;

FIG. 3 is a side plan schematic view of the tilting inversion exerciser;

FIGS. 4, 5 are side plan schematic views similar to FIG. 3, illustrating the operation of the tilting inversion exerciser; and

FIG. 6 is a perspective view similar to FIG. 1, illustrating the other arrangement of the tilting inversion exerciser.

### DETAILED DESCRIPTION OF THE PREFERRED EMBODIMENT

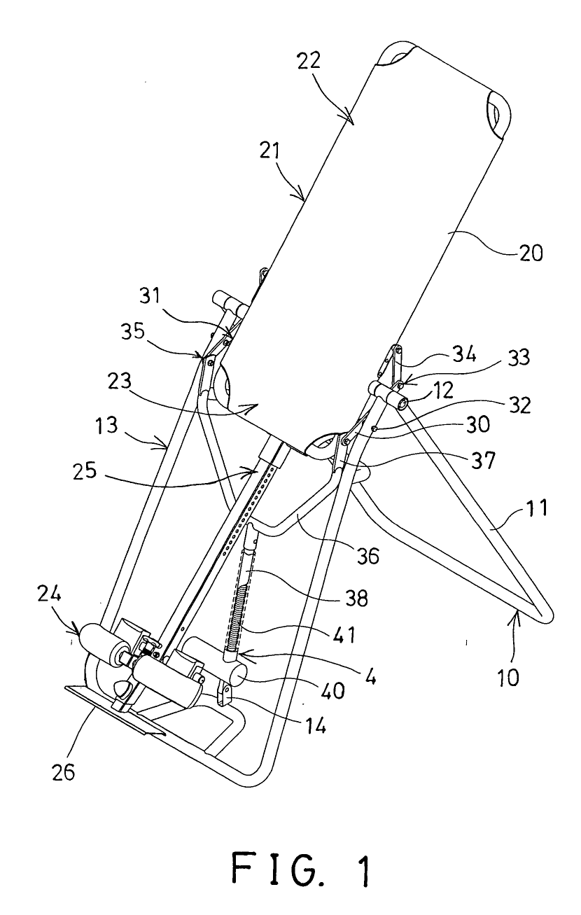

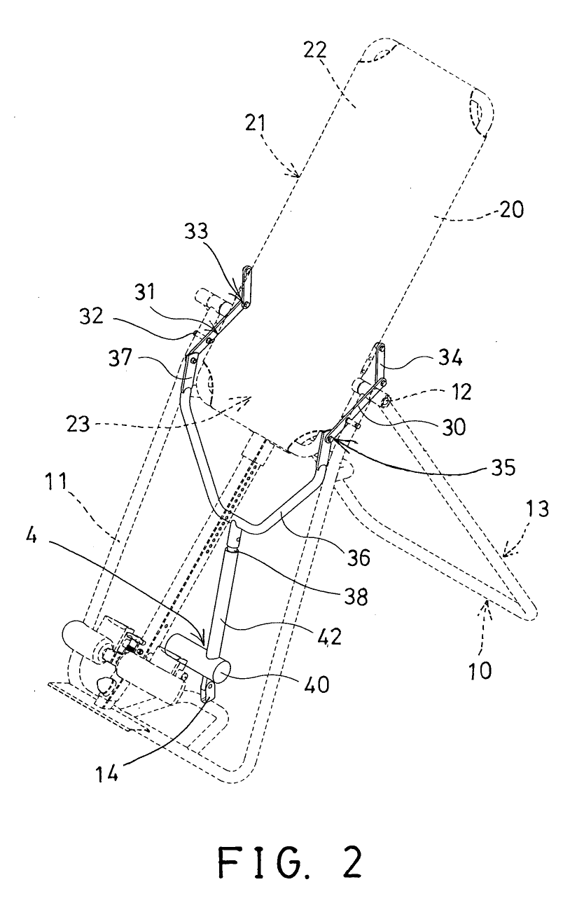

Referring to the drawings, and initially to FIGS. 1-3, a tilting inversion exerciser in accordance with the present invention comprises a lower supporting stand 10 for pivotally or rotatably supporting a base or table 20 thereon, and for supporting a user on the table 20, the lower supporting stand 10 includes such as two pairs of legs 11 having upper ends pivotally coupled together with a pivot axle 12, so as to form two inverted V-shaped frames 13. The table 20 may also be pivotally or rotatably attached to and supported on the lower supporting stand 10 with the pivot axle 12.

The table 20 includes two opposite side edges 21, and includes one end or upper portion 22 located above the pivot axle 12, and the other end or lower portion 23 located below the pivot axle 12. The table 20 further includes an ankle holder 24 adjustably attached or secured or coupled to the lower portion 23 thereof with an adjustable extension 25, for detachably securing the ankle portions of the user to the table 20, and a foot pedal 26 attached to the ankle holder 24 or the adjustable extension 25, for supporting the user thereon.

One or more, such as two levers 30 each includes a middle or intermediate portion 31 pivotally or rotatably attached or secured to the lower supporting stand 10 with a pivot shaft 32 respectively, and each includes one end 33 pivotally coupled to the upper portion 22 of the corresponding side edges 21 of the table 20 with a link 34, and the other end 35 pivotally coupled to a frame 36, such as pivotally coupled to two ends 37 of the frame 36 respectively. The frame 36 includes a tube 38 extended therefrom.

A power rotating or driving device 4 is provided for rotating the table 20 relative to the lower supporting stand 10 and for allowing the table 20 to be rotated relative to the lower support to a vertical position relative to the lower supporting stand 10 and the ground, and includes a motor 40 pivotally or rotatably attached or secured to a bracket 14 of the lower supporting stand 10, and a bolt or threaded member 41 threaded with the tube 38 (FIG. 1) and coupled to and rotated and driven by the motor 40, for allowing the threaded member 41 and the tube 38 to be extended or retracted relative to each other, and thus for rotating the levers 30 and thus the table 20 relative to the lower supporting stand 10.

It is preferable that the power rotating or driving device 4 further includes a sleeve 42 attached to or extended from the motor 40, and engaged onto the threaded member 41, for shielding and protecting the threaded member 41, and for preventing the threaded member 41 from being exposed. The sleeve 42 may also be provided for shielding the threaded member 41, and for preventing the users from being hurt by the threaded member 41 and the sleeve 42.

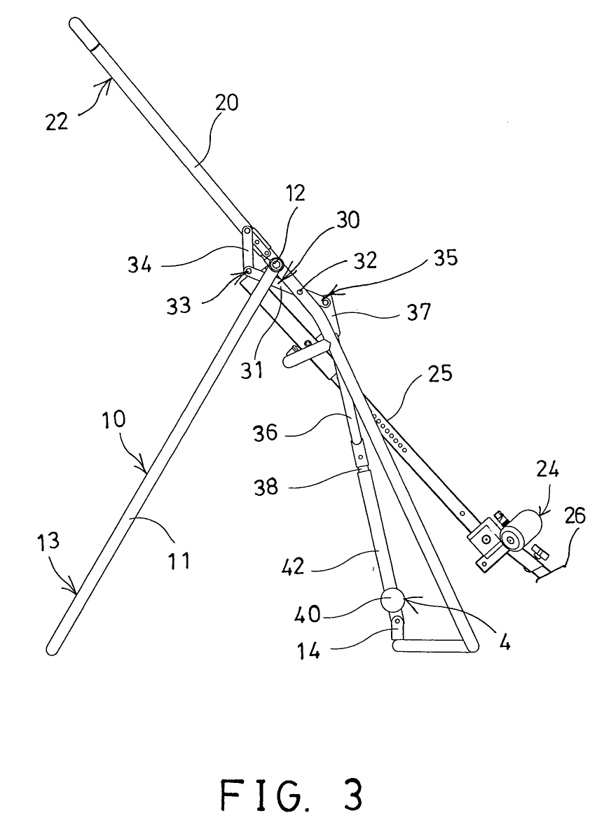

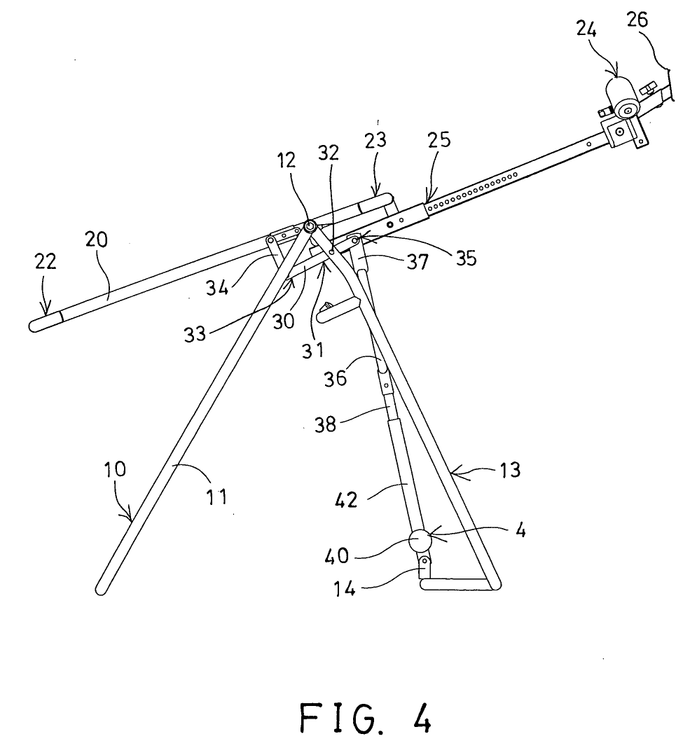

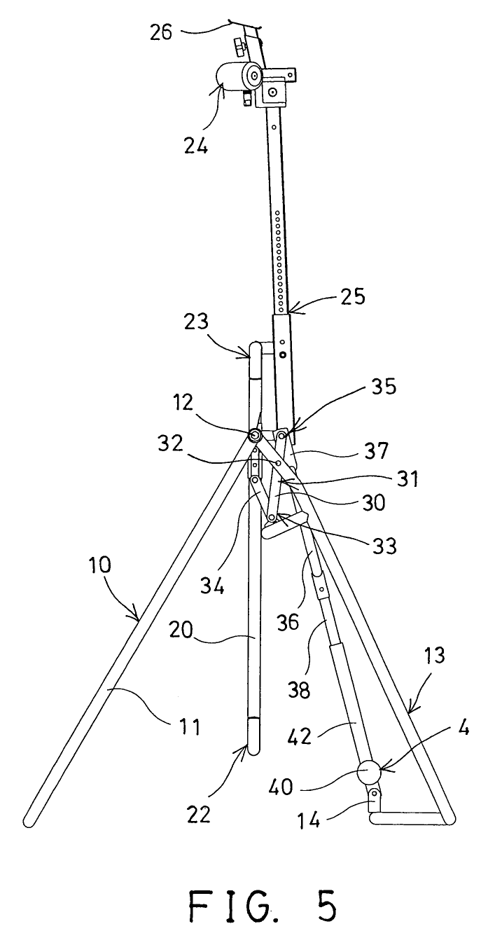

In operation, as shown in FIGS. 3-5, the user may be supported on the table 20 and may have his ankle portion detachably attached to or secured to the table 20 with the ankle holder 24. The power rotating or driving device 4 may be used as a rotating means to rotate the levers 30 and thus the table 20 relative to the lower supporting stand 10, to allow the table 20 to be rotated to a position completely perpendicular to the ground (FIG. 5), and to allow the user to be freely suspended above the ground to comfortably conduct the tilting inversion exercises when the table 20 is vertically supported on the lower supporting stand 10.

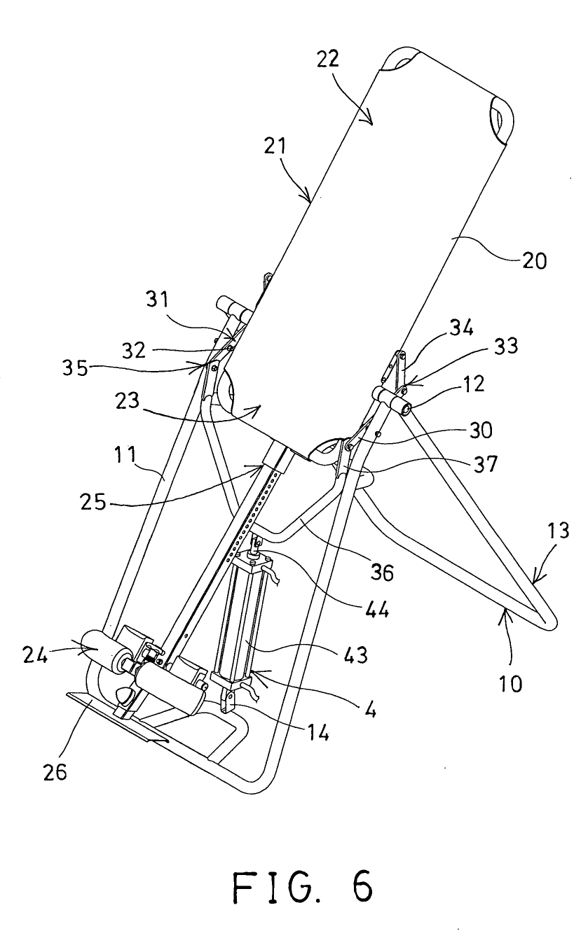

Alternatively, as shown in FIG. 6, the power rotating or driving device 4 may include an actuator 43, such as a pneumatic or hydraulic cylinder 43 pivotally or rotatably attached or secured to the bracket 14 of the lower supporting stand 10, and includes a piston rod 44 extended therefrom and coupled to the frame 36 for rotating the levers 30 and thus the table 20 relative to the lower supporting stand 10.

It is to be noted that, with the coupling of the levers 30 to the table 20, the frame 36 and the tube 38 are required to be extended or moved relative to the lower supporting stand 10 for only a short moving stroke, by the motor 40 of the power rotating or driving device 4, to allow the table 20 to be rotated to the position completely perpendicular to the ground. The link 34 and the frame 36 and the tube 38 and the power rotating or driving device 4 are all located below the table 20, and will not be contacted by the user that is supported above the table 20.

Accordingly, the tilting inversion exerciser in accordance with the present invention includes a power rotating or driving device for rotating the tilting inversion exerciser relative to the supporting stand and for allowing the table to be rotated relative to the lower support to the vertical position relative to the lower support and the ground, and thus for allowing the user to conduct the inversion exercises.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tilting inversion exerciser comprising:
a supporting stand,
a table rotatably supported on said supporting stand for supporting a user thereon,
at least one lever including a middle portion rotatably attached to said supporting stand with a pivot shaft, and includes a first end pivotally coupled to said table, and
means for rotating said at least one lever relative to said supporting stand, to rotate said table relative to said supporting stand.

2. The tilting inversion exerciser as claimed in claim 1, wherein said table includes an upper portion coupled to said first end of said at least one lever with a link.

3. The tilting inversion exerciser as claimed in claim 1, wherein said table includes an ankle holder attached thereto, for securing ankle portions of the user to said table.

4. The tilting inversion exerciser as claimed in claim 1, wherein said at least one lever includes a second end, said rotating means includes a motor-driven threaded member coupled to said second end of said at least one lever, for rotating said at least one lever relative to said supporting stand.

5. The tilting inversion exerciser as claimed in claim 4, wherein said rotating means includes a tube coupled to said second end of said at least one lever and threaded with said threaded member.

6. The tilting inversion exerciser as claimed in claim 5, wherein said rotating means further includes a frame having a first end pivotally coupled to said second end of said at least one lever and having said tube extended therefrom.

7. The tilting inversion exerciser as claimed in claim 4, wherein said rotating means includes a motor attached to said supporting stand, and said threaded member is coupled to and rotated and driven by said motor.

8. The tilting inversion exerciser as claimed in claim 7, wherein said motor includes a sleeve extended therefrom and engaged onto said threaded member 41, for shielding and protecting said threaded member.
